(19) United States
(12) Patent Application Publication
(10) Pub. No.: US 2005/0049018 A1
(43) Pub. Date: Mar. 3, 2005

(54) Mobile communication device

(75) Inventors: Che-Chih Chiang, Taichung (TW); Ching-Yu Lin, Hsinchu (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/929,315

(22) Filed: Aug. 30, 2004

(30) Foreign Application Priority Data
Sep. 1, 2003 (TW) TW92124078

(51) Int. Cl. H04M 1/00; H04B 1/38

(52) U.S. Cl. 455/575.1; 455/550.1

(57) ABSTRACT

A mobile communication device. The mobile communication device comprises a main body and a speaker selectively projected from the main body and inserted into user's ear to obtain better audio quality.

### BACKGROUND OF THE INVENTION

1. Field of the Invention

The present invention relates to a mobile communication device, and in particular to a mobile communication device having a projected speaker.

2. Description of the Related Art

A conventional mobile communication device, for example, a cell phone, wireless intercom etc, is provided with a speaker mounted inside the mobile communication device. The conventional cell phone either provides insufficient volume or poor audio quality when the volume is increased. If the volume is increases to be sufficiently loud for a person hearing impaired person, it disturbs others.

U.S. Pat. No. 6,532,292 discloses a speaker inserted into user's ear, the speaker however is external rather than mounted in the mobile communication device.

R.O.C. patent 275742 discloses a personal communication device having a supported speaker for insertion into user's ears. As with the conventional cell phone, it is difficult to use and may disturb others.

### SUMMARY OF THE INVENTION

Accordingly, an object of the invention is to provide a mobile communication device.

The invention provides a mobile communication device having a projected speaker capable of easy insertion into user's ear.

The mobile communication device of the invention comprises a main body having a receiver for converting a received radio signal into a vocal signal and a speaker selectively projecting from the main body and coupled to the receiver.

The mobile communication device further comprises a base and a connector. The base is disposed on the main body and rotatable on a first axis by 90°. The connecter is rotated around a second axis by 360°. The first axis is perpendicular to the second axis. The main body further has a recess accommodating the speaker.

Several mechanisms can be utilized to eject the speaker from the recess. The main body may have a button, which when pushed causes the speaker to spring from the recess. The main body may have a phone key and a solenoid, the solenoid is actuated to eject the speaker from the recess when the phone key is pushed. The main body may further have a location button which when pressed projects the speaker from the recess.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1a is a perspective view of the first embodiment of the invention;

FIG. 1b is a schematic view showing the cell phone of the invention in use;

FIG. 2 is a perspective view of the second embodiment of the invention;

FIG. 3a is a perspective view of the third embodiment of the invention;

FIG. 3b is a cross section along A-A line in FIG. 3a;

FIG. 4a is a perspective view of the fourth embodiment of the invention; and

FIG. 4b is a cross section along B-B line in FIG. 4a.

### DETAILED DESCRIPTION OF THE INVENTION

The invention is applicably to a variety of many mobile communication devices including cell phones in the following. A cell phone is given as an example.

### FIRST EMBODIMENT

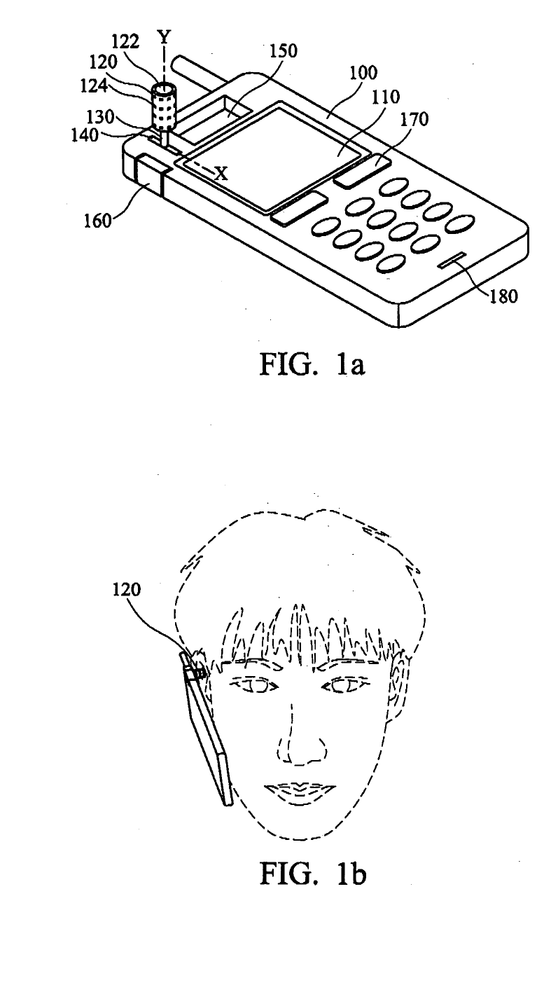

As shown FIG. 1a, a speaker 120 is connected to a base 140 through a connector 130. The base 140 is disposed on a main body 100. The main body 100 is including a screen 110 and a microphone 180. Because the base 140 can pivotally rotate on an X axis by 90°, the speaker 120 can be accommodated in a recess 150. The connector 130 can rotate on a Y axis by 360° to facilitate insertion of the speaker 120 into on ear and adjustment thereof. As shown in FIG. 1b, the main body 100 further has a receiver (not shown) coupled to the speaker 120 for receiving and converting a radio signal to a vocal signal.

When a user accepts an incoming call, a push bottom 160 is pressed to project the speaker 120 from the recess 150. In addition to the button 160, a phone key 170 and a solenoid (not shown) can also be used. When the phone key 170 is pressed, the solenoid is actuated to project the speaker 120 from the recess 150. The button 160 can also be designed as a location button, i.e. when the button 160 is pressed; the speaker 120 will project out of the recess and retracts when released.

In addition, the speaker 120 is configured as a is column with a first speaker hole 122 on the top thereof and a plurality of second speaker holes 124 around the periphery thereof, enabling a user to listen to a call without springing out the speaker 120.

### SECOND EMBODIMENT

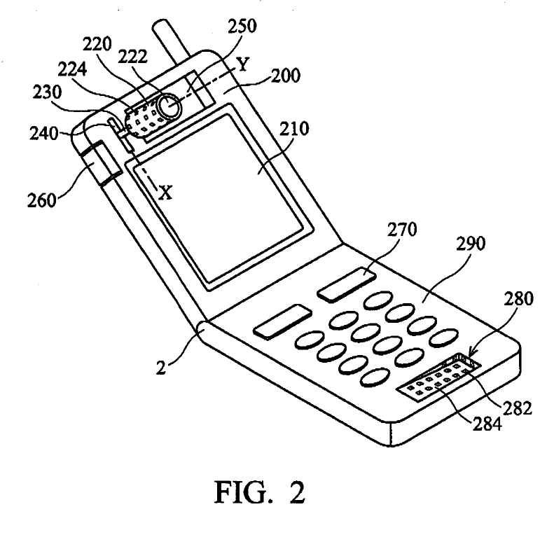

As shown in FIG. 2, the cell phone in this example is a foldable cell phone. The main body of the cell phone includes an upper body 200 and a lower body 290. The upper body 200 is connected to the lower body 290 by a hinge 2 and a LCD screen 210 on the upper body 200. A speaker 220 is connected to a base 240 by a connector 230. The base 240 is disposed on the upper body 200. As shown in the first embodiment, the base 240 can rotate on an X axis by 90°. The upper body 200 has a first recess 250, and the lower body 290 has a corresponding second recess 280 provided with an incline 284. When the main body is folded, the speaker 220 is pressed by the incline 284 and causing it accommodated in to retract into the space formed by the first recess 250 and the second recess 280. The connector 230 can rotate on a Y axis by 360° for easy insertion of the speaker 220 into user's ear for adjustment thereof. The upper body 100 further has a receiver (not shown) coupled to the speaker 220 for receiving and converting a radio signal to a vocal signal.

To engage an incoming call, the folded main body is opened and a button 260 on the upper body 200 is pressed to project the speaker 220 out of the first recess 250. In addition to the button 260, a phone key 270 and a solenoid (not shown) can also be used. When the phone key 270 is pressed, the solenoid is actuated to project the speaker 220 out of the recess 250. The bottom 260 can also be designed as a location button, i.e. when the bottom 260 is pressed, the speaker 220 will project out of the recess, and when released the speaker 220 is accommodated in the recess 250.

In addition, the speaker 220 is configured as a column with a first speaker hole 222 on the top thereof and a plurality of second speaker holes 224 around the periphery thereof, enabling a user to listen to a call without projecting the speaker 220.

The second recess 280 may have a plurality of sound holes 282.

### THIRD EMBODIMENT

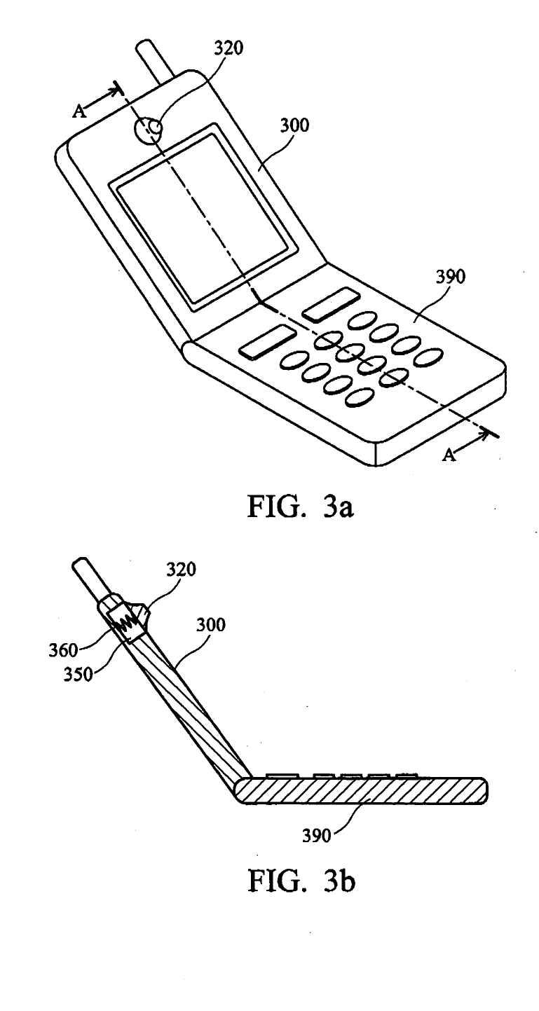

The cell phone in this embodiment is the same as the cell phone described in the first embodiment, except that the speaker 320 is configured as a cone shown in FIGS. 3a, 3b. An upper body 300 has a recess 350. A spring 360 is set in the recess 350 and contacts the speaker 320. When the cell phone is folded, the speaker 320 is accommodated in the recess and the spring 360 is compressed. When the folding cell phone is open, the speaker 320 is projected out.

### FOURTH EMBODIMENT

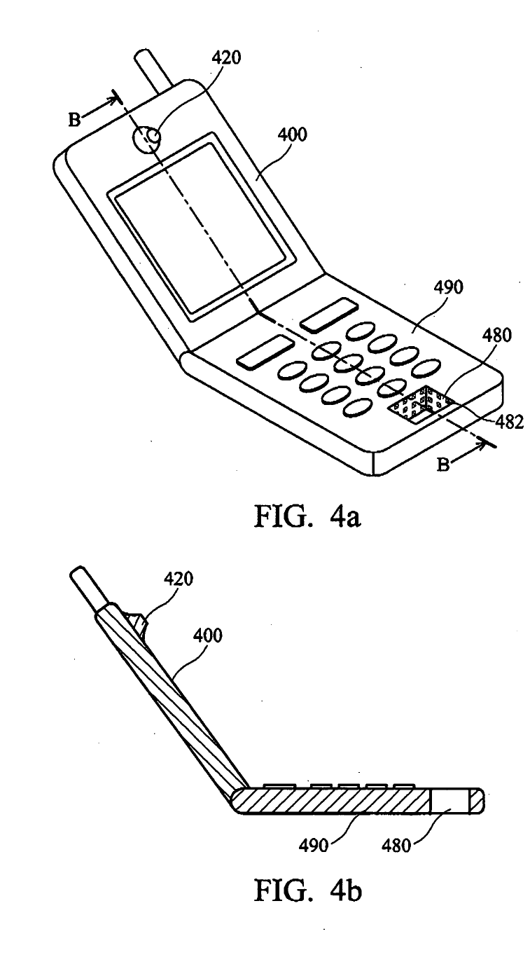

As shown in FIGS. 4a, 4b, the speaker 420 has the same shape as the speaker 320. A lower body 490 of the cell phone has a recess for accommodating the speaker 420. However, the lower body 490 may alternatively have a through hole 480 for accommodating the speaker 420. The through hole 480 is provided with a plurality of sound holes 482.

In addition, the speaker may have a thermometer for measuring user's body temperature upon taking a phone call.

The mobile communication device of the invention is provided with a projecting speaker for insertion into an user's ear to promote better listening quality and particularly useful for the hearing impaired. In addition, the speaker has a thermometer for measuring user's body temperature. Compared with conventional cell phones, the invention provides additional functions.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A mobile communication device, comprising:
a main body having a receiver for receiving and converting a radio signal to audio signal; and
a speaker for selectively projecting from the main body and coupled to the receiver to output the audio signal.

2. The mobile communication device as claimed in claim 1 further comprising a base mounted on the main body and a connecter, the speaker connecting the base via the connecter.

3. The mobile communication device as claimed in claim 2, wherein the base is disposed on the main body and pivotally rotates on a first axis by 90°, and the connecter is disposed on the base and rotates on a second axis by 360°.

4. The mobile communication device as claimed in claim 3, wherein the main body further has a recess accommodating the speaker.

5. The mobile communication device as claimed in claim 4, wherein the main body further has a button, the speaker projecting out of the recess when the button being pressed.

6. The mobile communication device as claimed in claim 4, wherein the main body further has a key and a solenoid, the solenoid is actuated causing the speaker to project out of the recess when the key is pressed.

7. The mobile communication device as claimed in claim 4, wherein the main body further has a location button, and the speaker projects out of the recess when the locating bottom is pressed and the speaker is accommodated in the recess when the location button is released.

8. The mobile communication device as claimed in claim 1, wherein the main body has an upper body in which the speaker is set, a lower body and a hinge connecting the upper body and the lower body.

9. The mobile communication device as claimed in claim 8 further comprising a base mounted on the upper body and a connecter, the speaker connecting the base via the connecter.

10. The mobile communication device as claimed in claim 9, wherein the base is disposed on the upper body and rotates on a first axis by 90°, and the connecter is disposed on the base and rotates on a second axis by 360°.

11. The mobile communication device as claimed in claim 10, wherein the upper body has a first recess accommodating the speaker.

12. The mobile communication device as claimed in claim 11, wherein the lower body has a second recess corresponding to the first recess, and the speaker can be accommodated in a space formed by the first recess and the second recess.

13. The mobile communication device as claimed in claim 12, wherein the second recess has an incline pushing the speaker into the space formed by the first and second recess.

14. The mobile communication device as claimed in claim 12, wherein the second recess has a plurality of sound holes for outputting audio.

15. The mobile communication device as claimed in claim 10, wherein the main body further has a button, the speaker projects out of the first recess when the button is pressed.

16. The mobile communication device as claimed in claim 10, wherein the main body further has a key and a solenoid, the solenoid is actuated to project the speaker out of the recess when the key being pressed.

17. The mobile communication device as claimed in claim 10, wherein the main body further has a location button and the speaker projects out of the recess when the location button is pressed and retracts into the recess when the location button is released.

18. The mobile communication device as claimed in claim 8 further comprising a spring disposed between the speaker and the upper body, wherein the spring is compressed when the speaker is accommodated in the upper body.

19. The mobile communication device as claimed in claim 8, wherein the lower body has a recess for accommodating the speaker when the main body is folded.

20. The mobile communication device as claimed in claim 19, wherein the recess has a plurality of sound holes for outputting audio.

21. The mobile communication device as claimed in claim 8, wherein the lower body has a through hole for accommodating the speaker when the main body is folded.

22. The mobile communication device as claimed in claim 21, wherein the through hole has a plurality of sound holes for outputting audio.

23. The mobile communication device as claimed in claim 1, wherein the shape and size of the speaker are varied according to the ear, and the speaker has a first speaker hole on the top thereof and a plurality of-second speaker holes around the periphery thereof.

24. The mobile communication device as claimed in claim 1, wherein the speaker has a thermometer for measuring body temperature.
